(19) United States
(12) Patent Application Publication
(10) Pub. No.: US 2012/0130850 A1
(43) Pub. Date: May 24, 2012

(54) TECHNIQUES AND SYSTEM FOR REVENUE SHARING IN AN ONLINE STOREFRONT

(75) Inventor: Clifford Akihiko Suzuki, Redmond, WA (US)

(73) Assignee: MICROSOFT CORPORATION, Redmond, WA (US)

(21) Appl. No.: 12/950,228

(22) Filed: Nov. 19, 2010

(51) Int. Cl. G06Q 30/00; G06Q 20/00

(52) U.S. Cl. 705/26.8

(57) ABSTRACT

Techniques to provide dynamic revenue sharing among product providers in an online storefront are described. In an embodiment, products are bundled into packages. When a package is purchased, licensed or subscribed to, the payment received may be shared with online storefront, and among the product providers according to the rank of the products in the package. Partners of the online storefront may design their own packages and receive a portion of the payment. Other embodiments are described and claimed.

### BACKGROUND

Conventional online storefronts may offer products in a pay-per-download or a blanket subscription fee structure. These fee structures may not provide adequate revenue streams for product developers. The fee structures may discourage partnerships with developers and other entities. These fee structures may be blind to product quality.

It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to provide revenue sharing from products sold in an online storefront. Some embodiments are particularly directed to techniques to providing revenue sharing with channel partners of the online storefront host. In one embodiment, for example, a technique may include bundling products into packages for download. Payment for a downloaded package may be shared among the online storefront, and the developers of the products in the package. The percentage of the shared portion received by a developer may depend on the quality or other ranking metric of the product, relative to the other products in the package. The percentage of the shared portion may be determined dynamically as the ranking metric values for the products change. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a system for dynamic revenue sharing.

FIG. 2 illustrates a block diagram of an online storefront.

FIG. 3 illustrates a block diagram of an example of revenue distribution according to embodiments.

FIG. 4 illustrates an embodiment of a logic flow.

FIG. 5 illustrates an embodiment of a computing architecture.

FIG. 6 illustrates an embodiment of a communications architecture.

### DETAILED DESCRIPTION

Various embodiments are directed to systems and techniques for sharing revenue among product developers and partners from an online storefront. In an embodiment, products, e.g. software applications, software updates, services, or digital content, may be bundled together into packages. When a package is purchased, licensed, or subscribed to, one portion of the fee may be set aside for the online storefront, while a second portion may be distributed among the providers of the products in the package, e.g., the developers. The percentage of the second portion shared with a particular developer may depend on the product rank, as compared to the other products in the package. Additionally, partners of the online storefront host may provide their own packages, and may receive a third portion of the fee when their packages are purchased. As a result, the embodiments can improve revenue sharing for product developers selling or licensing products via an online storefront.

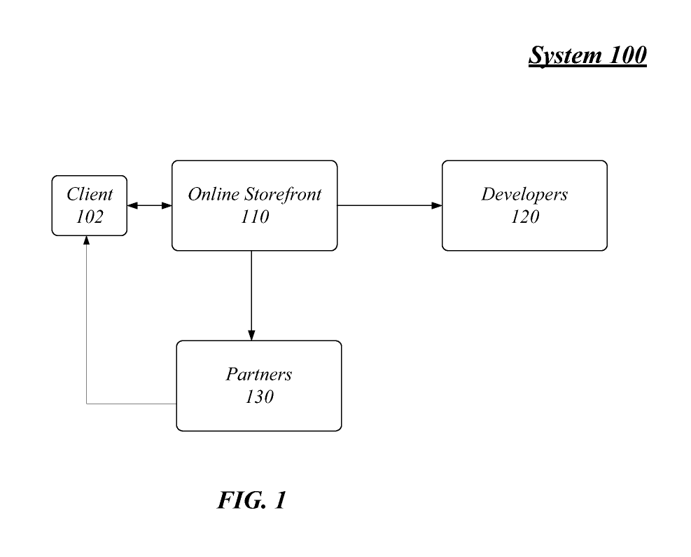

FIG. 1 illustrates a block diagram for a system 100 to share revenue from an online storefront. In one embodiment, for example, the system 100 may comprise a computer-implemented system 100 having one or more components, such as client 102 and online storefront 110. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 102, 110 may be communicatively coupled via various types of communications media to each other and to developers 120 and partners 130. The components may coordinate operations among each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In various embodiments, the system 100 may comprise client 102. Client 102 may be a computing device that is operative to display the online storefront interface, and allow the user of client 102 to browse, search, and/or pay to download products from online storefront 110.

In various embodiments, the system 100 may comprise online storefront 110. Online storefront 110 may provide an interface, for example, via a web browser, that lists products for download. Online storefront 110 may store the files that constitute the products for download. Online storefront 110 may accept payment information, such as a credit card number or bank account number, and may coordinate the receipt of payment from the user. Online storefront 110 may determine a percentage of a payment to provide to the developers 120 of the products in the downloaded package. Online storefront 110 may further determine a percentage or a flat fee to share with partners 130 that have provided a package for download.

In various embodiments, the system 100 may comprise developers 120. Developers 120 may include software developers selling or licensing products via the online storefront. As used herein, developers 120 may also include content providers that may not have developed the product themselves, but have the rights to offer a product for sale or licensing. Developers 120 may be, generally, separate, independent entities from the online storefront 110.

In various embodiments, the system 100 may comprise one or more partners 130. Partners 130 may include other independent entities, such as, but not limited to, original equipment manufacturers (OEMs), retailers, or telecommunications companies (telecoms). Partners 130 may be able to set up their own packages of products within the online storefront 110 that may be licensed or sold with the partner 130 brand, and perhaps only to customers of the partner 130.

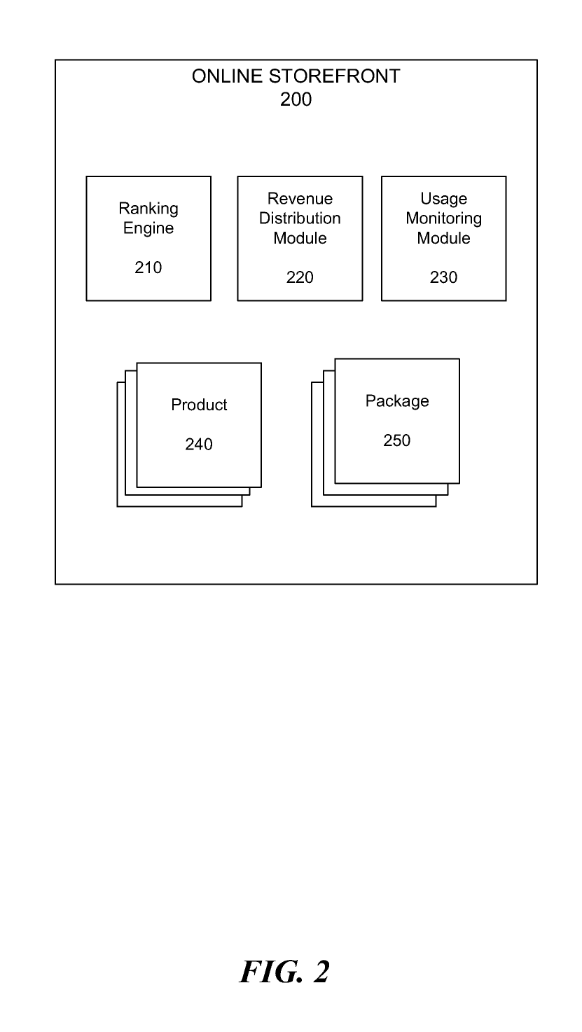

FIG. 2 illustrates a block diagram of an online storefront 200. Online storefront 200 may be an example of online storefront 110. Online storefront 200 may include one or more components to implement its functionality. For example, online storefront 200 may include a ranking engine 210, a revenue distribution module 220, and/or a usage monitoring module 230.

Online storefront 200 may store products 240 for download. Online storefront 200 may also or alternatively have access to one or more computer-readable storage media that store products 240. Products 240 may be bundled into various packages 250. A product 240 may be included in more than one package 250. A package 250 may be organized by a theme, such as, but not limited to, games, top-selling products, productivity applications, top-rated products, or partner-specified packages.

In an embodiment, a package 250 may be dynamic, and/or the payment may be a form of subscription. For example, a “top-ten games” package may provide, for a monthly flat fee, a subscription to the top-ten ranked games of the online storefront. The contents of the package may change each month, according to new offerings and historical rankings of game products.

Partner packages may include, for example, applications, services and/or warranties that are provided with or for an equipment item, such as a mobile phone, laptop computer, desktop computer, or other device. Partner packages may be directed to a specific type of hardware, such as a laptop computer or tablet computer.

Ranking engine 210 may rank products 240 according to one or more factors. Ranking factors may include, for example, product usage, product quality, or product reputation. Ranking engine 210 may compute an average or a weighted average of the ranking factors to determine a numeric rank for each product offered in online storefront 200. Product usage is described below. Product quality may include, for example, measures of application stability. Product reputation may include, for example, measures from product ratings and reviews. The weights of the ranking factors may be reconfigured to adjust the rankings.

Revenue distribution module 220 may, when a payment for a package is received, distribute the payments to the developers of the products in the package. Revenue distribution module 220 may reserve a first portion of the payment for the online storefront, for example, as a hosting fee. The remainder of the payment may be distributed among the developers that have products in the package. If the package is a partner package, a third portion of the payment may be sent to the partner, for example, as a partner package fee. In an embodiment, revenue distribution module 220 may distribute payment according to product rank. Developers of products that have a higher rank may receive a larger percentage of the payment than developers of products with a lower rank. In an embodiment, products may be sorted according to rank into tiers, where the tier determines a percentage of the payment that the developer receives.

Usage monitoring module 230 may measure or monitor the amount of use that a product receives and provide the usage information to ranking engine 210. Examples of product usage may include, for example, a number of views of the product in the online storefront; an amount of time the product was used on a client that downloaded it; a number of times the product was launched on a client that downloaded it; or a number of unique users of the product. The embodiments are not limited to these examples. Products that are used more may receive a higher ranking than products used less often. In an embodiment, usage monitoring module 230 may operate outside of online storefront 200 and provide the usage data to online storefront 200.

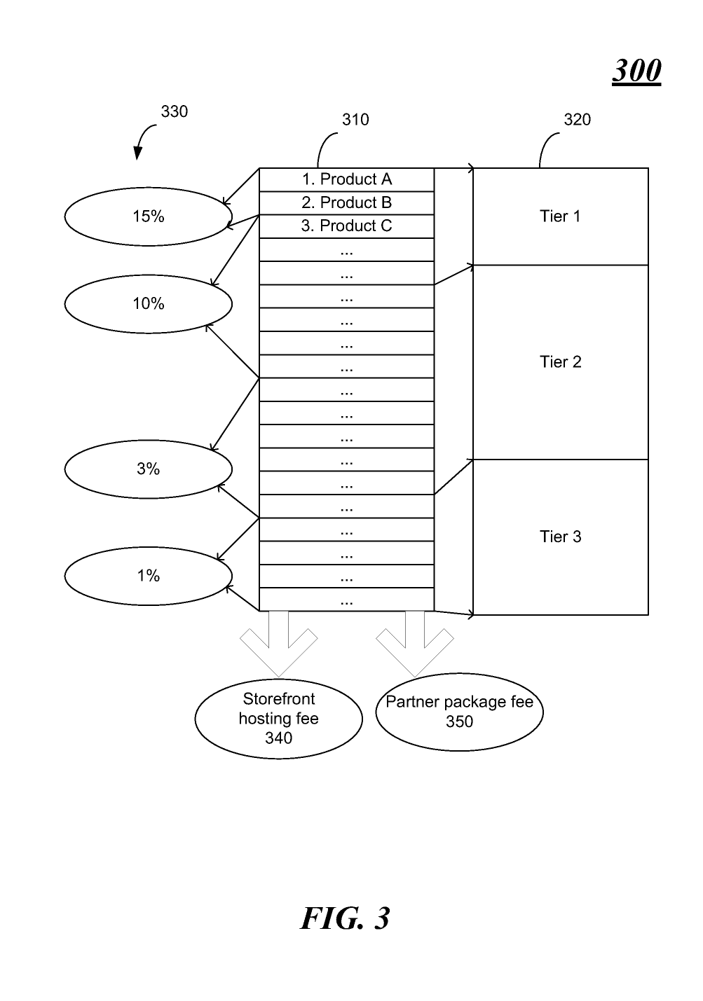

FIG. 3 illustrates a block diagram 300 of an example of revenue distribution according to various embodiments. Package 310 may include several products sorted by product rank. The products in package 310 may be sorted into tiers 320, according to rank. For example, in a package of 20 products, the top 5 products may be sorted into tier 1, the middle 10 may be sorted into tier 2, and the last 5 products may be sorted into tier 3. Developers of the products in package 310 may receive payment according to which tier their product is in. For example, products in tier 1 may receive 10%, tier 2 may receive 3%, and tier 3 may receive 1%. The remainder may be paid as online storefront hosting fee 340. Online storefront hosting fee 340 may be a flat fee or a percentage of the package price. If the package is a partner bundle, part of the remainder may be paid to the partner as partner package fee 350. In an embodiment, the package products may not be explicitly sorted into tiers, but their position in the ranked list of package 310 may determine what percentage 330 that their respective developers receive.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

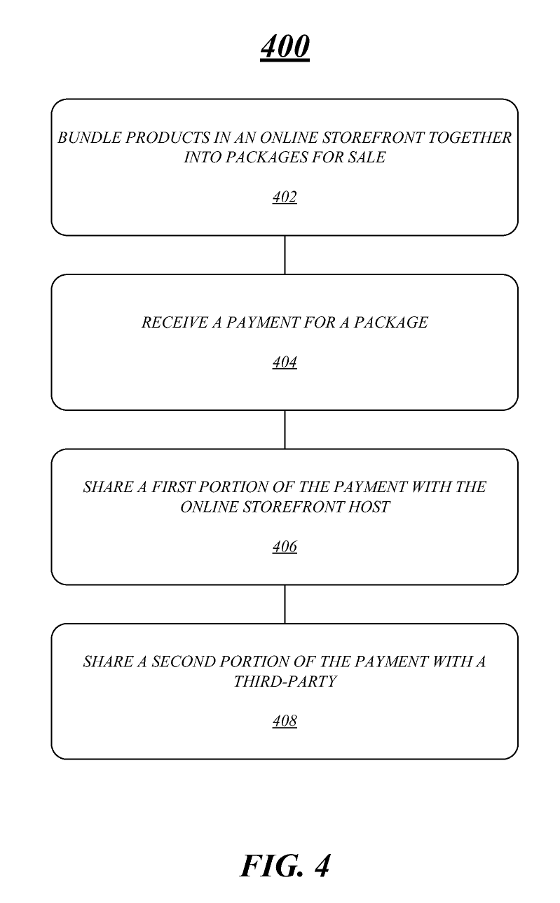

FIG. 4 illustrates one embodiment of a logic flow 400. The logic flow 400 may be representative of some or all of the operations executed by one or more embodiments described herein.

In the illustrated embodiment shown in FIG. 4, the logic flow 400 may bundle products into packages in an online storefront at block 402. For example, two or more products may be grouped together for sale, subscription, or licensing. Bundling may be done manually, or may be automatic according to one or more criteria. Products may be bundled according to a theme, such as application type, ranking, popularity, release date, hardware type, etc. A product may be removed from a bundle when it no longer meets the criteria.

The logic flow 400 may receive a payment for a package at block 404. For example, a user may provide payment information such as a credit card number via client 102 in exchange for being able to download a package to client 102, and to use the package products for the subscribed to period of time.

The logic flow 400 may share a first portion of the payment with the online storefront host at block 406. For example, the entity that provides the online storefront 110 may receive a flat fee or a percentage of the package price.

The logic flow 400 may share a second portion of the payment with a third-party entity at block 408. For example, each of the developers having products in the purchased package may receive a percentage of the payment. As described above, the percentage received may be determined by the rank of the product. The percentage received by a particular developer of a product may change dynamically as the ranking of the product changes. High quality or popular products may thus generate more revenue over time than poor quality or unpopular products, which may encourage developers to improve their offerings.

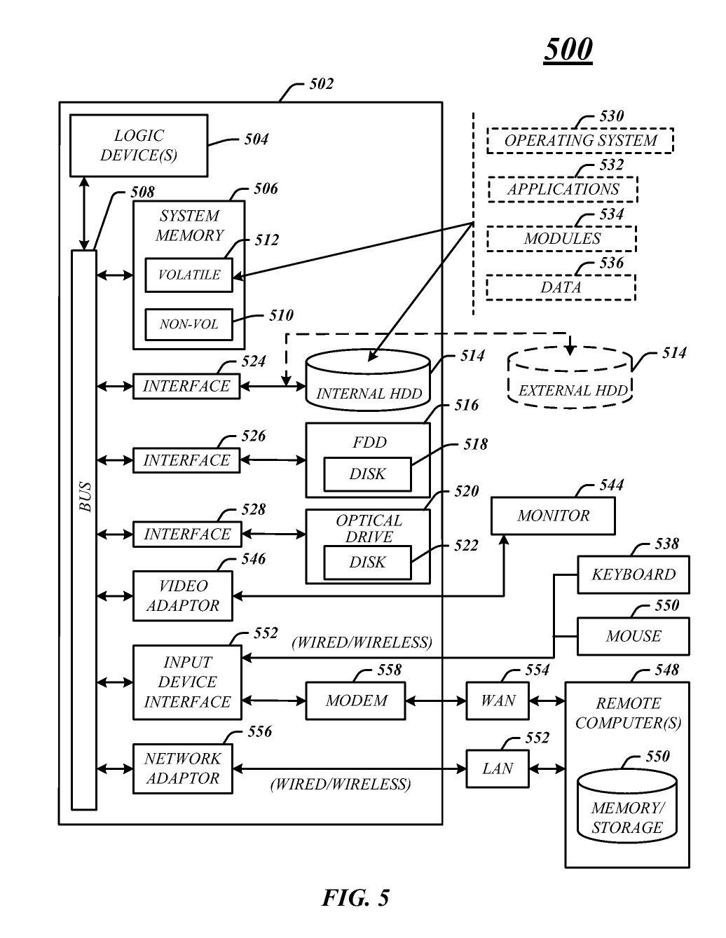

FIG. 5 illustrates an embodiment of an exemplary computing architecture 500 suitable for implementing various embodiments as previously described. The computing architecture 500 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 500.

As shown in FIG. 5, the computing architecture 500 comprises logic device(s) 504, a system memory 506 and a system bus 508. Examples of a logic device may include, without limitation, a central processing unit (CPU), microcontroller, microprocessor, general purpose processor, dedicated processor, chip multiprocessor (CMP), media processor, digital signal processor (DSP), network processor, co-processor, input/output processor, application specific integrated circuit (ASIC), field programmable gate array (FPGA), programmable logic device (PLD), and so forth. Dual microprocessors and other multi-processor architectures may also be employed as the logic device(s) 504. The system bus 508 provides an interface for system components including, but not limited to, the system memory 506 to the logic device(s) 504. The system bus 508 can be any of several types of bus structure that may further interconnect to a memory bus (with or without a memory controller), a peripheral bus, and a local bus using any of a variety of commercially available bus architectures.

The system memory 506 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 5, the system memory 506 can include non-volatile memory 510 and/or volatile memory 512. A basic input/output system (BIOS) can be stored in the non-volatile memory 510.

The computer 502 may include various types of computer-readable storage media, including an internal hard disk drive (HDD) 514, a magnetic floppy disk drive (FDD) 516 to read from or write to a removable magnetic disk 518, and an optical disk drive 520 to read from or write to a removable optical disk 522 (e.g., a CD-ROM or DVD). The HDD 514, FDD 516 and optical disk drive 520 can be connected to the system bus 508 by a HDD interface 524, an FDD interface 526 and an optical drive interface 528, respectively. The HDD interface 524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 510, 512, including an operating system 530, one or more application programs 532, other program modules 534, and program data 536. The one or more application programs 532, other program modules 534, and program data 536 can include, for example, the ranking engine 210, revenue distribution module 220, and/or usage monitoring module 230.

A user can enter commands and information into the computer 502 through one or more wire/wireless input devices, for example, a keyboard 538 and a pointing device, such as a mouse 540. Other input devices may include a microphone, an infra-red (IR) remote control, a joystick, a game pad, a stylus pen, touch screen, or the like. These and other input devices are often connected to the logic device(s) 504 through an input device interface 542 that is coupled to the system bus 508, but can be connected by other interfaces such as a parallel port, IEEE 1394 serial port, a game port, a USB port, an IR interface, and so forth.

A monitor 544 or other type of display device is also connected to the system bus 508 via an interface, such as a video adaptor 546. In addition to the monitor 544, a computer typically includes other peripheral output devices, such as speakers, printers, and so forth.

The computer 502 may operate in a networked environment using logical connections via wire and/or wireless communications to one or more remote computers, such as a remote computer 548. The remote computer 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wire/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wire and/or wireless device, connects to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

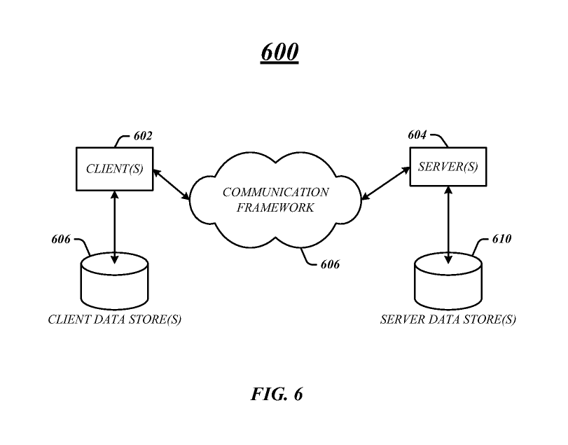

FIG. 6 illustrates a block diagram of an exemplary communications architecture 600 suitable for implementing various embodiments as previously described. The communications architecture 600 includes various common communications elements, such as a transmitter, receiver, transceiver, radio, network interface, baseband processor, antenna, amplifiers, filters, and so forth. The embodiments, however, are not limited to implementation by the communications architecture 600.

As shown in FIG. 6, the communications architecture 600 comprises includes one or more clients 602 and servers 604. The clients 602 may implement the client system 102. The servers 604 may implement the server system 110. The clients 602 and the servers 604 are operatively connected to one or more respective client data stores 608 and server data stores 610 that can be employed to store information local to the respective clients 602 and servers 604, such as cookies and/or associated contextual information.

The clients 602 and the servers 604 may communicate information between each other using a communication framework 606. The communications framework 606 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 602 and the servers 604 may include various types of standard communication elements designed to be interoperable with the communications framework 606, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 602 and a server 604 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
bundling products in an online storefront together into packages for sale, wherein at least one product is developed by a third-party entity different from the online storefront host;
receiving a payment for a package;
sharing a first portion of the payment with the online storefront host; and
sharing a second portion of the payment with the third-party.

2. The method of claim 1, further comprising:
bundling products for a partner of the online storefront host in a partner package; and
sharing a third portion of a payment for the partner package with the partner.

3. The method of claim 1, wherein the package products are developed by a plurality of third-party entities, the method further comprising:
ranking the products in the package; and
sharing the second portion of the payment among the plurality of third-party entities according to the product rank.

4. The method of claim 3, wherein ranking comprises:
ranking according to ranking factors comprising at least one of: product usage, product reputation, and product quality.

5. The method of claim 4, further comprising:
calculating rank as a weighted average of at least two ranking factors.

6. The method of claim 3, further comprising:
sorting the ranked products into at least two revenue sharing tiers, wherein the tier determines a percentage of the second portion of the payment that the third-party will receive.

7. The method of claim 6, further comprising:
sharing a larger percentage with a third-party having a higher ranked product in a first tier; and
sharing a smaller percentage with a third-party having a lower ranked product in a second tier.

8. The method of claim 3, wherein bundling products comprises removing a product from a bundle when the product rank falls below a threshold.

9. The method of claim 1, further comprising:
receiving payments periodically for the package.

10. An article comprising a storage medium containing instructions that when executed cause a system to:
receive a payment at an online storefront for a package comprising bundled products, wherein at least one product is developed by a third-party entity different from the online storefront host;
share a first portion of the payment with the online storefront host; and
share a second portion of the payment with the third-party.

11. The article of claim 10, wherein the package products are developed by a plurality of third-party entities, the article further comprising instructions that when executed cause the system to:
rank the products in the package; and
share the second portion of the payment among the plurality of third-party entities according to the product rank.

12. The article of claim 11, wherein the instructions to rank comprise instructions that when executed cause the system to:
compute a weighted average of at least two of:
a number of views of the product;
an amount of time the product was used;
a number of times the product was launched;
a number of unique users of the product;
a quality measure of the product; and
a reputation of the product; and
sort the products according to the weighted average.

13. The article of claim 11, further comprising instructions that when executed cause the system to:
sort the ranked products into at least two revenue sharing tiers, wherein the tier determines a percentage of the second portion of the payment that the third-party will receive.

14. The article of claim 13, further comprising instructions that when executed cause the system to:
share a larger percentage with a third-party having a higher ranked product in a first tier; and
share a smaller percentage with a third-party having a lower ranked product in a second tier.

15. The article of claim 11, further comprising instructions that when executed cause the system to:
automatically generate a package based on top ranked products.

16. An apparatus, comprising:
a logic device;
an online storefront executing in the logic device to share a first portion of a payment with the online storefront host, wherein the payment is for a package comprising bundled products, wherein at least one product is developed by a third-party entity different from the online storefront host, and to share a second portion of the payment with the third-party.

17. The apparatus of claim 16, wherein the package products are developed by a plurality of third-party entities, the online storefront further to:
rank the products in the package; and
share the second portion of the payment among the plurality of third-party entities according to the product rank.

18. The apparatus of claim 17, the online storefront further to:
sort the ranked products into at least two revenue sharing tiers;
share a larger percentage with a third-party having a higher ranked product in a first tier; and
share a smaller percentage with a third-party having a lower ranked product in a second tier.

19. The apparatus of claim 17, the online storefront further to:
rank according to ranking factors comprising at least one of: product usage, product reputation, and product quality

20. The apparatus of claim 16, the online storefront further to:
bundle products for a partner of the online storefront host in a partner package; and
share a third portion of a payment for the partner package with the partner.
